(19) United States
(12) Patent Application Publication
(10) Pub. No.: US 2010/0185714 A1
(43) Pub. Date: Jul. 22, 2010

(54) DISTRIBUTED COMMUNICATIONS BETWEEN DATABASE INSTANCES

(75) Inventors: Robert H. Gerber, Bellevue, WA (US); Alexandre Verbitski, Woodinville, WA (US); Viatcheslav Krassovsky, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/353,992

(22) Filed: Jan. 15, 2009

(51) Int. Cl. G06F 17/30

(52) U.S. Cl. 707/966; 707/E17.032; 707/912

(57) ABSTRACT

A database communication system is described herein that structures communications in a way that provides lower overhead tracking, statistics, semantics for closing a communication, and reliability. The system provides communication namespaces that organize communications by component, purpose, and instance, which allow database servers to implicitly create communication-related objects without central coordination. The database communication system enables group-based communications that streamline the development of complex distributed components and protocols by providing creation and management of communications namespaces, centralized cleanup support, and centralized monitoring. These features allow the system to be highly distributed, with no one single coordinator of operations, and still provide reliable communications. Thus, the system allows databases to be spread across multiple servers while keeping the burden on database server developers of managing communications between the servers low.

### BACKGROUND

In the past, databases ran on one server (e.g., a database management system (DBMS)). However, with the increasingly large applications supported by database servers, distributed architectures that provide scalability and fail-over are becoming more common. When a database designer distributes data across multiple database servers (sometimes called a cluster), the database servers often need to communicate to perform operations on data that may be stored on two or more servers. For example, a query may identify data on two or more servers, and responding to the query may involve communicating the query to each server and obtaining a response that includes any matching data items stored on that server.

The first challenge in this type of environment is distinguishing the component of the database server to which received communications belong. Although only a single Transmission Control Protocol (TCP) link may connect each pair of database servers, the link may handle communications for many components of each database server. The receiver has to determine which component received data is for to route the data to the proper component.

A second challenge is tracking communications between multiple servers. A sending server may send communications to many receiving servers, and want to determine which receiving servers received the communications, which receiving servers have not yet responded to the communications, and so forth. As the list of receiving servers grows large, the challenge of managing these communications increases. In some cases, other servers may be interested in the state of the communications. For example, if Server A sends a message to Servers B and C, then Server A fails or an administrator takes down Server A for planned maintenance, it may fall to Server B to continue the operation. In typical systems, Server B is not even aware of Server C, so it is challenging for Server B to determine which receiving servers have received and/or responded to a communication to continue the operation. As another example, if a message sent from A to C travels through intermediate site B, A has no way to infer the state of communications between B and C.

A third challenge is cleaning up context information stored for the communications. As noted above, a server may track a large amount of information related to particular communications. When the communications are complete or when a server in the system determines that the communications are to be shut down, there is often no well-defined way to inform each of the distributed servers to clean up the stored information (e.g., on disk or in memory) related to the communications. Thus, operations that are complete, but for which the server is still tracking information may continue to consume valuable server resources. These resources are unavailable for additional operations or customer transactions, reducing the scalability of the system.

A fourth challenge is ensuring reliability of communications. In some cases, a component would like to request reliable service guarantees, such as acknowledgements of sent messages. Microsoft SQL Server 2005 introduced the SQL Service Broker, which allows processes to send reliable messages between database instances on the same or different servers. However, this type of reliability includes acknowledgments for each message, and thus has a high overhead and creates high network traffic between communicating servers. For more routine communications, the overhead of this type of reliability is often too resource intensive. In addition, it is often difficult for an administrator to determine which component or communications are causing a bottleneck in communications.

### SUMMARY

A database communication system is described herein that structures communications in a way that provides lower overhead tracking, statistics, semantics for closing a communication, and reliability. The database communication system enables group-based communications that streamline the development of complex distributed components and protocols by providing creation and management of communications namespaces, centralized cleanup support, and centralized monitoring (e.g., of message loss). The system provides communication namespaces that organize communications by component, purpose, and instance. The system also provides for implicit management of object lifetimes at each distributed server by implicitly creating objects related to the message based on a specified namespace. The message specifies namespace information that allows the receiving server to determine which objects will handle the message (e.g., this allows the system to be distributed with no single coordinator of operations). The system also provides a force close operation that allows any system participant to close a communication on each of the servers in the system. Finally, the system provides statistics and monitoring information that allow servers in the system to determine whether messages have been lost and to determine the status of communications without the burden that comes with acknowledging every message received. These features allow the system to be highly distributed, with no one single coordinator of operations, and still provide reliable communications. Thus, the system allows a database designer to spread databases across multiple servers while keeping the burden of managing communications between the servers low.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the database communication system, in one embodiment.

FIG. 2 is a block diagram that illustrates a typical operating environment of the system, in one embodiment.

FIG. 3 is a flow diagram that illustrates the processing of the implicit context creation component, in one embodiment.

FIG. 4 is a table diagram that illustrates the contents of a channel-orchestrated route for a cluster of two servers, in one embodiment.

FIG. 5 is a flow diagram that illustrates the processing of the force close component, in one embodiment.

### DETAILED DESCRIPTION

### Overview

A database communication system is described herein that structures communications in a way that provides lower overhead tracking, statistics, semantics for closing a communication, and reliability. The database communication system enables group-based communications that streamline the development of complex distributed components and protocols by providing creation and management of communications namespaces, centralized cleanup support, and centralized monitoring (e.g., of message loss). The system allows multiple database servers to act upon received requests in a coordinated manner (e.g., as if they were a single database server).

The system includes four categories of functionality, each discussed in further detail in the sections below. First, the system provides communication namespaces that organize communications by component, purpose, and instance. For example, using the communication namespaces, the system can distinguish messages received over a single communication stack that are related to multiple database components. In addition, the communication namespaces allow a message recipient to implicitly determine the context of a message. The system also provides for implicit management of object lifetimes at each distributed server. For example, a server may not create context related to a distributed operation until the server receives a message related to the operation. The message specifies namespace information that allows the receiving server to determine where the message goes and which objects handle the message.

The system also provides a force close operation that allows any system participant to close a communication on each of the servers in the system. For example, if a server detects that messages have been lost for a particular query, the server can force each of the other servers to abort the query. Finally, the system provides statistics and monitoring information that allows servers in the system to determine whether messages have been lost and the status of communications without the burden that comes with acknowledging every message received. Each of these categories of functionality allows the system to be highly distributed with no one single coordinator of operations, and still provide reliable communications. Thus, the system allows databases to be spread across multiple servers while keeping the burden on database server developers of managing communications between the servers low.

### System Components

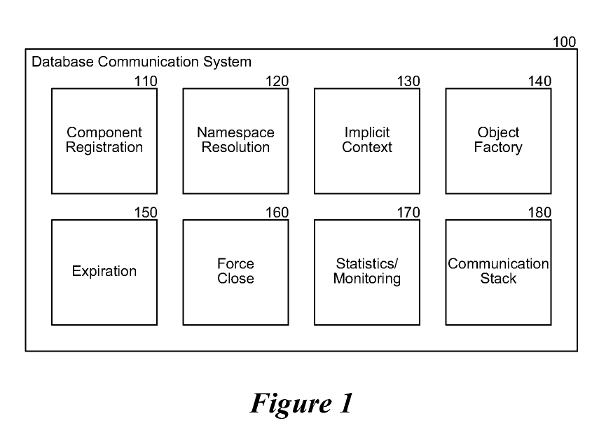

FIG. 1 is a block diagram that illustrates components of the database communication system, in one embodiment. The system 100 includes a component registration component 110, a namespace resolution component 120, an implicit context component 130, an object factory component 140, an expiration component 150, a force close component 160, a statistics and monitoring component 170, and a communication stack component 180. Each of these components is described in further detail herein.

The component registration component 110 provides a facility for registering new communication components with the system 100. The system 100 allows developers to add new components to the system 100 to perform new functions. The new components utilize the database communication system 100 to perform communication operations between database instances. Each component has an associated namespace by which the system 100 identifies the component. When a developer creates a new component, the developer uses the component registration component 110 to inform the system 100 about the new component and to provide a facility for the system 100 to call when messages arrive specifying the namespace associated with the component.

The namespace resolution component 120 receives messages from the communication stack component 180 and determines a namespace associated with the message. Based on the associated namespace, the namespace resolution component 120 determines the channel map, conversation, and channel to which the message belongs and invokes the appropriate communication components to handle the message.

The implicit context component 130 identifies software objects based on the arrival of messages that will handle the messages. For example, based on the namespace associated with a message, the implicit context component 130 may identify a channel map, conversation, channel, and/or local participant with which the message is associated. Although instances of the objects may already exist on the sending server, the receiving server may be learning about the objects for the first time based on the namespace of the message. However, the namespace specifies enough information for the receiving server to determine if instances of the specified objects already exist on the receiving server, and if they do not already exist, to create the objects. The implicit context component 130 allows the system to lazily create objects and for each particular endpoint to only become involved in a communication at the point at which there is a message for the endpoint to process in accordance with the namespace associated with the communication. This relieves the system 100 from heavyweight session creation semantics with each of the distributed servers and from tracking any global state of the communications. For example, traditional systems often provide a central coordinator that: 1) first communicates with each recipient (or potential recipient) of a communication that is part of a distributed operation to create a context for receiving the communication, then 2) sends the communication to each recipient, and finally 3) collects status information about the outcome of the operation from each recipient. The implicit context component 130 alleviates the first step of this process and instead provides enough information in the second step to create the context for receiving the communication. In addition, the statistics and monitoring component 170, discussed further below, alleviates the third step.

The object factory component 140 creates objects determined by the implicit context component 130. For example, if a message references a local participant that has not yet been created, then the object factory component 140 creates a new local participant using a local participant factory object. The term factory is commonly used with the Component Object Model (COM) to specify a type of object used to create other objects, but may also refer to other similar technologies, such as the Microsoft NET Platform.

The expiration component 150 manages the lifetimes of implicitly created components. The object factory component 140 creates components as needed, and the expiration component 150 destroys the objects when they are no longer in use. The expiration component 150 may also provide information about the messages received and statistics about connections between endpoints (e.g., pipelines) to various requestors.

The force close component 160 provides a facility for reliably closing a channel or other communication objects in the database communication system 100. Because of the distributed nature of the communications, and no single coordinator managing the communications on each server, it is difficult to conclusively end an operation. The force close component 160 provides a facility that notifies each server in the system 100 when a requestor wants to conclude a communication. The force close component 160 may receive an acknowledgement from each server when the operation is complete and can notify the requestor of the status of the force close operation. This provides well-defined semantics for aborting or otherwise concluding a communication or series of communications. This protocol is also idempotent. For example, if servers A and B are involved in communication both of them (potentially multiple times and/or concurrently) may invoke the force close service with the same result.

The statistics and monitoring component 170 tracks information about communications, such as each participant to which a message was sent, the number of received communications, the size of messages received (e.g., bytes total), and other information. The statistics and monitoring component 170 may operate on each server or at a central location reachable by each of the servers. Servers and other requesters can query the statistics and monitoring component 170 to receive information about statistics gathered at a particular server. In addition, the statistics and monitoring component 170 can compare statistics of various local participants and match send and receive statistics to detect message loss or other conditions of the communications.

The communication stack component 180 provides a low-level stack for sending and receiving messages between servers. The component 180 may use TCP/IP or other common protocols for the lower-level stack or a custom protocol. The stack is lower level in that it provides communications between a sender and receiver but is not necessarily aware of the meaning or purpose of the communications (as defined herein). The communication stack component 180 may maintain a single connection between each server or may create connections for various purposes (e.g., for each component). The other components of the system 100 allow the communication stack component 180 to be simplified since the component 180 is relieved of many common burdens. For example, the component 180 does not have to provide reliable message delivery or separation of messages by component because the system 100 provides these functions at a higher level.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

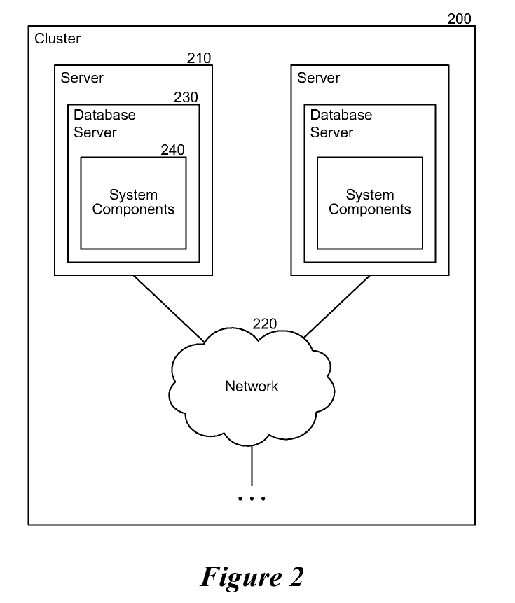

FIG. 2 is a block diagram that illustrates a typical operating environment of the system, in one embodiment. A cluster 200 includes multiple servers, such as server 210, connected via a network 220, such as the Internet or a Local Area Network (LAN). Each server may include one or more database servers, such as database server 230. The database server 230 may include one or more of the system components 240 described herein. The system allows each server to act as a peer with no one server acting as a coordinator of operations. When one database server goes down or an administrator makes a database server inactive, other database servers in the cluster can continue operations.

### Communications Namespaces

The database communication system defines a hierarchical namespace to which communications using the system adhere that allows a common approach for component developers to design, troubleshoot, and monitor distributed communications.

Each database component that sends distributed communications uses a channel type to distinguish its traffic from the traffic of other components. In some embodiments, channel types are statically defined by the system, one per distributed component. Channel types typically have three-part names in the form Type.Scope.Name, where Type is a type of a channel (e.g., Control, Mesh, and so on), Scope is either Global or Database, and Name is a descriptive name. For example, one channel type is “Mesh.Global.Query.”

A channel map is a versioned instance of a channel type that components can instantiate at run time. For example, a channel map of the above channel type is “Mesh.Global.Query.1.” Versions allow message recipients to determine an instance of the channel type with which a message is associated. As a cluster configuration changes, the system creates new instances of channel maps with the next version.

Within channel maps, a component creates channels and conversations. A channel separates component communications along any criterion that is useful to the component, such as functional purpose. For example, a component could create a channel for conveying status information. A channel is a logical concept that represents a specific message exchange within a channel map. A conversation identifies a set of related communications within a particular channel. For example, within the above status channel, a conversation may include a status update request and one or more status update responses from various server recipients of the request.

Within conversations, there are local participants and pipelines. A local participant is a logical concept that represents a specific addressee within a conversation, such as a local database server. A pipeline represents links to other participants/servers (i.e., remote endpoints) in the conversation. A pipeline is a logical point-to-point connection of each participant that controls and tracks communications with each distinct remote participant of a conversation with which the local participant communicates.

Following is an example of items within the namespace for a particular query component:

| | |
|---|---|
| Channel Type: | Mesh.Global.Query |
| Channel Map: | Mesh.Global.Query.1 |
| Channel: | Q1 (query instance) |
| Conversation: | Q1.Ex1 (query exchange) |
| Participant: | Q1.Ex1.P1 (producer/consumer) |

In some embodiments, the database communication system provides a context associated with each local participant. The local participant context allows a component to set or remove a user-defined object on a system-managed local participant. The local participant context is useful to accommodate scenarios where there is no permanent thread that is running on behalf of the participant (e.g., an activation-only scenario). The local participant context allows the component to set a context to get access to the local participant's state from activation to activation. In addition, the local participant context allows the system to deliver out of band errors to a permanent thread. For example, when the participant's thread is doing useful work (or is blocked), the component can use the context to set the participant's thread identification information so that an error handler can identify the thread.

### Implicit Context Creation/Cleanup

The database communication system includes implicit context object creation and centralized cleanup of released objects, as described further herein. This streamlines development of distributed components by reducing the burden on the component of startup/cleanup orchestration.

In traditional communications, connections and other communication paradigms or typically created explicitly. For example, a sender opens a channel to a receiver, and the receiver listens for communications. In some embodiments, the database communication system creates channels and conversations implicitly. For example, when a message arrives at a node, the arrival of the message creates channels and conversations based on the namespace associated with the arriving message.

When a message arrives (e.g., via a TCP connection), the system picks up the message on a control service thread. The control service thread resolves the name of the destination based on namespace information in the message that contains a channel name, conversation name, and local participant identifier.

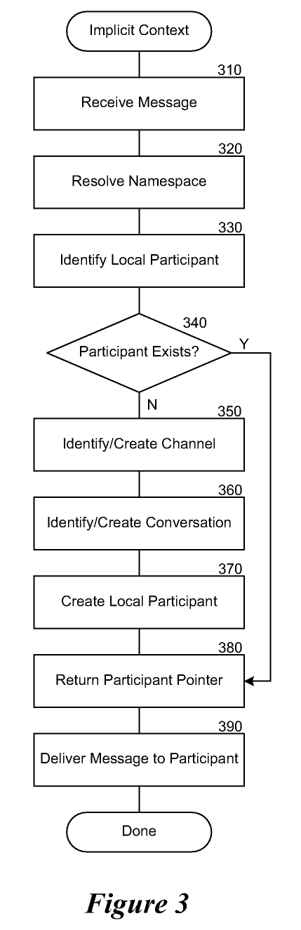

FIG. 3 is a flow diagram that illustrates an example implicit context creation process, in accordance with one embodiment. This process can, for example, be performed by a component such as the implicit context component 130. In block 310, the component receives a message from the network. For example, a client application may invoke a query that sends a message to each server to gather data responsive to the query. In a next block 320, the component resolves the intended recipient of the message based on namespace information within the message. From block 320, control proceeds to block 330, where the component determines if a local participant object exists to receive the message. For example, the component may look up the local participant in a hash table based on a local participant identifier in the received message. In a next decision block 340, if the local participant object exists, then the component jumps to block 380, else the component continues at block 350.

In block 350, the component resolves the channel name based on the namespace information. If the channel object does not yet exist (e.g., a channel object for handling a distributed query), then the component creates the object (or invokes another component, such as the object factory component 140 to create the object). Following block 350, control proceeds to block 360, where the component resolves the conversation name. If the conversation object does not yet exist, then the component creates the object (or invokes another component to create the object). In a next block 370, the component invokes a local participant factory (e.g., object factory component 140) to create a new local participant. In a next block 380, the component provides a pointer to the existing local participant object. For example, the component may add a reference to the object and return the object pointer. Following block 380, control proceeds to block 390, where the component delivers the received message to the local participant. Thus, the component creates whatever objects do not already exist implicitly based on the namespace information in the received message. After block 390, these steps conclude.

In some embodiments, the database communication system provides an expiration service that cleans up unused objects. The system attributes each communication in the system to one or more communication objects, which the system may have implicitly created as described herein. The expiration service works in the background, collecting information about use of communication objects and discarding unused communication objects. Typically, the service determines whether objects are still in use (e.g., based on whether they have been closed or references to the objects have been released) and expires unused objects. Alternatively or additionally, the system may expire objects after a fixed period, based on a timer, according to a heuristically determined lifetime, and so forth. Without the expiration service, a particular endpoint does not know when a channel is no longer in use unless a force close is received as described herein. If messages continue to arrive, the system will hold the channel open; otherwise, the expiration service will close the channel at each endpoint.

In some embodiments, the database communication system provides a channel-orchestrated route that defines a topology of the channel map and is stored within each channel map object as a table of member information data structures. Although the system can operate in a flat space without any hierarchical topology or routing table, the routing table allows an administrator or component to define relationships between database servers. The channel-orchestrated route allows a sender to direct a message to a named target and let the semantics of the channel implicitly send the message to intermediate targets for purposes of achieving an orchestrated purpose or semantic that is defined by the channel.

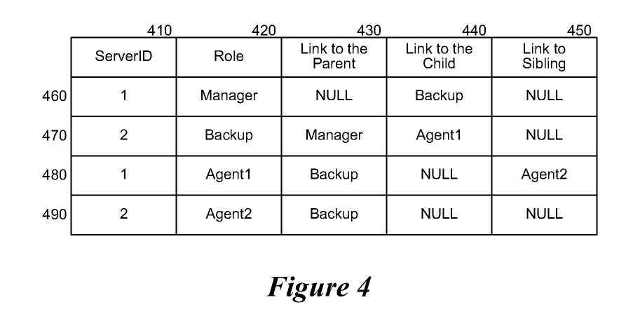

FIG. 4 is a table diagram that illustrates the contents of the routing table for a cluster of two servers, in one embodiment. Each member information data structure contains: 1) a server identifier 410 that identifies the server to which the member information refers, 2) a role 420 of the server member (e.g., primary manager, backup manager, or normal/agent), 3) a link to a parent member 430 that identifies a primary manager for a given backup manager or a backup manager for a given agent, 4) a link to a child member 440 that identifies the first backup manager for a given primary manager and the first agent for a given backup manager, 5) a link to a sibling 450 that identifies the next first backup manager for a given primary manager and the next agent for a given backup manager. The first row 460 in the table indicates that server ID 1 (Manager) contains a primary manager that is a parent to server Backup. The second row 470 indicates that server Backup is a child of server Manager, and a parent of server Agent1. The third row 480 indicates that server Agent1 is a child of server Backup and a sibling of server Agent2. The fourth row 490 indicates that server Agent2 is a child of server Backup. These definitions allow the database communication system to route messages to various servers in the system.

The components may be linked with the database server when it is provided by the manufacturer. Alternatively or additionally, in some embodiments, developers can provide new components to the database communication system after the system is deployed. A component developer supplies a new component that system administrator can install on servers within the database communication system. In either case, the component developer typically provides three handlers for the new component: OnChannelMapAnnounceHandler, OnChannelMapCreateHandler, and OnChannelMapInvalidateHandler. Each of the handlers receives a channel map object as a parameter.

The system calls the OnChannelMapAnnounceHandler handler when a new channel map is installed. Typically, this occurs when an administrator has just started the cluster or because of a configuration change, such as a server being added or deleted. The system calls the OnChannelMapCreateHandler handler when the new channel map is ready to be used. This handler is invoked after announce handlers have completed successfully on all nodes in the cluster. The system calls the OnChannelMapInvalidateHandler handler when the channel becomes invalid. This typically occurs due to server failures or additions. Users of the channel then obtain a new channel map object from the channel map manager or use one provided by the channel map functions described above.

In some embodiments, the database communication system provides an additional server failure notification to alert participants that have outstanding pipelines to a failed server. Each server that receives the notification enumerates each channel and conversation on the local server to determine if any have pipelines to the failed server. Then, the server notifies each local participant that has pipelines associated with the failed server so that the participant can take appropriate action (e.g., terminating the operation, involving a different remote server, and so on).

### Force Close Semantics

The database communication system provides a facility for a server or operator to force a particular operation to close, called the force close facility. Force close provides a way to address aspects of distributed protocols that expect a single coordinator. As discussed herein, communications within the database communication system are associated with a specific namespace. In certain situations, network protocols rely on a single coordinator. For example, an instance of a component on a single server typically serves as the coordinator with multiple instances of “secondary” state that are unaware of each other and reside on other servers. In the presence of coordinator failure, this creates a problem of how to invoke state cleanup mechanisms on the “secondary” state.

The channel force close facility provides semantics for channel cleanup in these circumstances. The force close facility operates similarly to the server failure notification described above, but the notification message indicates that it relates to a channel force close. Components invoke the force close facility by invoking a communication stack method and providing an identification of the channel to close. The communication stack then invokes channel manager functionality to deliver a force close request to the channel manager, which hosts a force close service. The force close service broadcasts force close orders to each server in the current cluster. Upon receiving acknowledgements from each server, the force close service responds to the force close requester indicating the outcome of the operation. If one of these operations fails, the force close facility will retry the failed operation a predefined number of times or during a specified time and then shut down the server. This in turn may start the next wave of cleanup in the system (e.g., of other force close operations are outstanding).

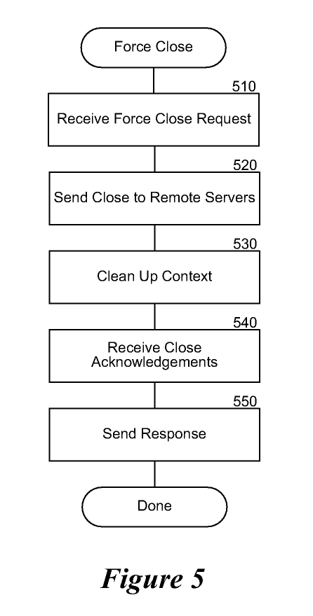

FIG. 5 is a flow diagram that illustrates the processing of the force close component, in one embodiment. In block 510, the component receives a request to force a channel to close. For example, a participant may send the request upon detecting a failure of one or more remote participants. In block 520, the component sends a force close order to each of multiple remote servers. For example, the component may broadcast a message to each server in a cluster over an Ethernet connection. In block 530, each server processes the force close order and cleans up context information related to the channel. In block 540, the component receives acknowledgements from the servers. For example, each server may respond to the force close order with an acknowledgement. In block 550, the component responds to the force close request. For example, the response may include information about the success or failure of communicating with each server and/or the overall success of the force close operation. After block 550, these steps conclude. After force close processing, the system modifies the state of the server in a manner that prevents further implicit activations of the context belonging to the same namespace.

### Statistics and Monitoring

The database communication system provides centralized pipeline monitoring to track statistics about communications between distributed servers. Centralized monitoring alleviates common reliability guarantee requirements (e.g., acknowledgements) from lower-level communication stack components. Rather than acknowledging every message, each participant periodically uploads statistical information to a central server. Participants can access the centrally stored statistical information to determine the status of communications. In the event of message loss, the tracked statistical information allows a server to efficiently detect the message loss and take appropriate action with respect to an ongoing operation (e.g., abort the operation).

Some protocols (e.g., query shutdown) expect reliable delivery guarantees from the communication stack. When messages are lost or cannot be delivered, the protocols may want to abort the operation or take other appropriate action. In traditional systems, a recipient acknowledges every message and the sender knows that a message has been lost when no acknowledgement is received. Acknowledgements increase the number of messages sent and received in a system because each message in one direction may generate a corresponding message in the opposite direction. By centrally collecting summary information about received messages, the database communication system allows a server to determine whether message loss has occurred without adding the overhead of acknowledgements.

Components conduct communications in the database communication system over logical pipelines between participants. In an example embodiment, each participant is capable of collecting statistical information about messages from each of the servers or from a central server and reconciling the pipeline statistics over both ends of pipeline. When information at one end of the pipeline does not match information at the other, message loss has occurred or can be presumed.

In some embodiments, the database communication system combines pipeline monitoring with the expiration service described herein. The expiration service periodically contacts each server and requests information about outstanding pipelines. Upon receiving the replies, the service aggregates responses and reconciles local statistical information with received statistical information. If the system detects a mismatch, the system raises a notification to components. This facility relieves the lower-level communication stack from providing reliable message delivery.

From the foregoing, it will be appreciated that specific embodiments of the database communication system have been described herein for purposes of illustration, but that various modifications may be made without deviating from the spirit and scope of the invention. For example, although the system has been described with respect to database servers, the system could be applied to other distributed server environments where communications are typically sent between servers, such as a hosted application cluster. Accordingly, the invention is not limited except as by the appended claims.

I/We claim:

1. A computer system for providing distributed database communications with lower overhead for database server developers and to allow multiple database servers to act upon received requests in a coordinated manner, the system comprising:
a processor and memory configured to execute software instructions;
a communication stack component configured to provide a low-level stack for sending and receiving messages between distributed database instances;
a component registration component configured to provide a facility for registering communication components with the system, wherein the communication components perform communication operations between distributed database instances;
a namespace resolution component configured to receive messages from the communication stack component and determine a namespace associated with the message;
an implicit context component configured to implicitly identify software objects based on an arrival of messages and in accordance with the namespace associated with the message;
an expiration component configured to manage the lifetimes of implicitly identified software objects, wherein the expiration component destroys the objects when they are no longer in use;
a force close component configured to provide a force close operation to close a logical communication channel distributed across multiple database instances, wherein the channel does not have a centralized coordinator that manages communications over the channel; and
a statistics and monitoring component configured to track information related to communications.

2. The system of claim 1 wherein the component registration component is further configured to associate a namespace with each registered communication component.

3. The system of claim 1 wherein the namespace resolution component is further configured to determine at least one of a channel map, conversation, and channel to which the message belongs based on the associated namespace and invoke a communication component to handle the message.

4. The system of claim 1 further comprising an object factory component configured to create objects using software instructions executed by the processor, wherein the objects are determined by the implicit context component to be related to the message but have not yet been created.

5. The system of claim 1 wherein the expiration component is further configured to determine whether a message has been received within a threshold period on a logical channel and in response to a determination that a message has not been received within a threshold period to close a local channel object and clean up resources associated with the local channel object.

6. The system of claim 1 wherein the force close component is further configured to notify each database instance in a cluster of database servers when a requestor wants to conclude a communication.

7. The system of claim 6 wherein the force close component is further configured to receive an acknowledgement from each database instance and to notify the requestor of the status of the force close operation.

8. The system of claim 1 wherein the statistics and monitoring component tracks the number or size of received communications at each database instance.

9. The system of claim 1 wherein the implicit context component is further configured to maintain a routing table that specifies relationships between two or more of the distributed database instances.

10. A computer-implemented method for managing communications between database instances, the method comprising:
receiving from a message sender a message over a network, wherein the message is part of a conversation between database instances related to a distributed database operation;
resolving a namespace associated with the message, wherein the namespace specifies a database component for handling the message and identifies context information associated with the message;
identifying a local database component in accordance with the specified database component of the namespace; and
delivering the received message to the local database component, wherein the local database component is configured to implicitly create objects specified by the namespace that do not already exist based on the namespace information in the received message,
wherein the receiving, resolving, identifying, and delivering are performed by at least one processor.

11. The method of claim 10 wherein identifying a local database component comprises determining whether an instance of the local database component has been previously created, and in response to a determination that an instance has not been previously created, creating an instance of the local database component.

12. The method of claim 10 wherein identifying a local database component comprises retrieving a local participant identifier from the message and looking up the local participant identifier in a local hash table.

13. The method of claim 10 further comprising identifying a logical channel based on the namespace associated with the message, wherein the logical channel distinguishes identifies a message type of the local database component.

14. The method of claim 10 further comprising identifying a logical conversation based on the namespace associated with the message, wherein the logical conversation separates communications within a logical channel of the local database component from other communications within the logical channel.

15. The method of claim 10 wherein the namespace specifies a version of a logical channel that changes when a database instance is added or removed from a cluster of database servers.

16. A computer-readable storage medium comprising instructions for controlling a computer system to close communications distributed among multiple database servers, wherein the instructions, when executed, cause a processor to perform actions comprising:
receiving a request to close a logical channel, wherein the channel identifies communications associated with a particular database component, wherein the communications are between multiple database server;
sending a close indication to each of the multiple database servers, wherein the close indication is configured to cause each database server to clean up context information related to the channel;
receiving acknowledgements from each of the multiple database servers, wherein each acknowledgement indicates a response of the corresponding database server to the close indication; and
after receiving the acknowledgements, responding to the received request to close the logical channel.

17. The computer-readable medium of claim 16 wherein sending a close indication to each of the multiple database servers comprises broadcasting the close indication on a local area network to which the database servers are connected.

18. The computer-readable medium of claim 16 wherein the request to close a logical channel comprises a request to abort a distributed query operation.

19. The computer-readable medium of claim 16 wherein the communications adhere to a hierarchical namespace that identifies the logical channel to which a particular message belongs.

20. The computer-readable medium of claim 16 wherein each database server tracks context information based on a hierarchical namespace associated with the logical channel.
